(19) United States
(12) Patent Application Publication
(10) Pub. No.: US 2022/0335868 A1
(43) Pub. Date: Oct. 20, 2022

(54) DISPLAY POSITION ADJUSTING METHOD AND APPARATUS, TERMINAL, AND READABLE STORAGE MEDIUM

(71) Applicant: ZTE Corporation, Shenzhen (CN)

(72) Inventor: Guofeng WU, Shenzhen (CN)

(21) Appl. No.: 17/764,412

(22) PCT Filed: Jun. 28, 2020
(86) PCT No.: PCT/CN2020/098633

§ 371 Date: Mar. 28, 2022

(30) Foreign Application Priority Data
Oct. 15, 2019 (CN) 201910979884.2

(51) Int. Cl. G09G 3/00; H04M 1/72454

(52) U.S. Cl. CPC G09G 3/035; H04M 1/72454; G09G 2354/00; G09G 2340/0478

(57) ABSTRACT

A display position adjustment method and device, a terminal device, and a non-transitory computer-readable storage medium are disclosed. The method may include: obtaining a current display position of a target component (S101); determining an adjustment scheme for the target component according to a preset display position, where the preset display position includes a position of the display position of the target component relative to a horizontal plane (S102); and adjusting the display position of the target component according to the adjustment scheme (S103).

### CROSS-REFERENCE TO RELATED APPLICATION

This application is a national stage filing under 35 U.S.C. § 371 of international application number PCT/CN2020/098633, filed on Jun. 28, 2020, which claims priority to Chinese patent application No. 201910979884.2 filed on Oct. 15, 2019. The contents of these applications are incorporated herein by reference in their entirety.

### TECHNICAL FIELD

Embodiments of the present disclosure relates to, but is not limited to, the field of mobile communication, in particular to but not limited to a display position adjustment method and device, a terminal device and a non-transitory computer-readable storage medium.

### BACKGROUND

Conceptual products with flexible displays were proposed in 2017, but they have not been applied in the market for various reasons. In February 2019, Huawei released mobile phones with foldable screens at the Mobile World Congress (MWC), and in April, Nubia released Alpha smart phones with flexible displays, so that the flexible display once again enter the public's field of vision. It is expected that a large number of smart terminal devices related to flexible displays will be available in the future, such as smart bracelets and smart watches.

At present, all flexible display products have a common shortcoming, that is, the fixation of the position of a display area or component can not adapt to the user's use, such as the position of time and notification.

Current flexible display apparatuses are bendable, which will lead to display screens of the apparatuses in a three-dimensional state. This will inevitably lead to the reduction of the user's visual range. This will hinder the popularization and application of flexible displays, such as existing bracelets with flexible displays, foldable mobile phones with flexible displays, and smart watches with flexible displays in the future.

At present, existing flexible display apparatuses all have fixed display positions, for example, main and auxiliary screens, or only a main screen or an auxiliary screen of a mobile phone with a foldable flexible display are/or used for display, and there is no scheme that the main and auxiliary screens are automatically switched for display.

For new flexible display devices such as bracelets or watches, display is performed at a fixed position relative to the terminal device.

Since automatic adaptation operations are not provided, as compared to embodiments of the present disclosure, all the current display schemes are poor in user experience, and require user intervention or experience reduction during adaption.

### SUMMARY

A display position adjustment method and device, a terminal device and a non-transitory computer-readable storage medium provided by the embodiments of the present disclosure solve at least one of the technical problems in the existing technology to a certain extent, including the problem whereby components are all displayed in relatively fixed positions relative to the terminal device and cannot be displayed according to the actual application scenarios and usage habits of users, and the user experience is low.

In view of this, an embodiment of the present disclosure provides a display position adjustment method, which is applied to a terminal device, the method may include: obtaining a current display position of a target component; determining an adjustment scheme for the target component according to a preset display position, where the preset display position includes a position of the display position of the target component relative to a horizontal plane; and adjusting the display position of the target component according to the adjustment scheme.

An embodiment of the present disclosure further provides a display position adjustment device, which is applied to a terminal device, the device may include: a first obtaining module configured to obtain a current display position of a target component; a first determination module configured to determine an adjustment scheme for the target component according to a preset display position, where the preset display position includes a position of the display position of the target component relative to a horizontal plane; and an adjustment module configured to adjust the target component according to the adjustment scheme to display the target component at the preset display position.

An embodiment of the present disclosure further provides a terminal device, which may include: a processor, a memory and a communication bus, where the communication bus is configured to implement connection and communication between the processor and the memory; and the processor is configured to execute one or more computer programs stored in the memory to implement steps of any one of the display position adjustment methods described above.

An embodiment of the present disclosure further provides a non-transitory computer-readable storage medium storing one or more computer programs, where the one or more computer programs are executable by one or more processors to implement steps of any one of the display position adjustment methods described above.

Other features and corresponding beneficial effects of the present disclosure are illustrated in later sections of the specification, and it should be understood that at least part of the beneficial effects become obvious from the specification of the present disclosure.

### BRIEF DESCRIPTION OF DRAWINGS

FIG. 1 is a schematic flowchart of a display position adjustment method provided by an example embodiment one of the present disclosure;

FIG. 2 is an implementation of display position adjustment provided by the example embodiment one of the present disclosure;

FIG. 3 is another implementation of display position adjustment provided by the example embodiment one of the present disclosure;

FIG. 4-1 is a further implementation of display position adjustment provided by the example embodiment one of the present disclosure;

FIG. 4-2 is a still further implementation of display position adjustment provided by the example embodiment one of the present disclosure;

FIG. 4-3 is a yet further implementation of display position adjustment provided by the example embodiment one of the present disclosure;

FIG. 5 is a yet further implementation of display position adjustment provided by the example embodiment one of the present disclosure;

FIG. 6 is a yet further implementation of display position adjustment provided by the example embodiment one of the present disclosure;

FIG. 7 is a yet further implementation of display position adjustment provided by the example embodiment one of the present disclosure;

FIG. 8 is a yet further implementation of display position adjustment provided by the example embodiment one of the present disclosure;

FIG. 9-1 is a yet further implementation of display position adjustment provided by the example embodiment one of the present disclosure;

FIG. 9-2 is a yet further implementation of display position adjustment provided by the example embodiment one of the present disclosure;

FIG. 10 is a schematic structural diagram of a display position adjustment device provided by an example embodiment two of the present disclosure; and

FIG. 11 is a schematic structural diagram of a terminal device provided by an example embodiment three of the present disclosure.

### DETAILED DESCRIPTION

In order to make the objectives, technical schemes and advantages of the present disclosure clear, the embodiments of the present disclosure will be further described below in detail with reference to the accompanying drawings. It should be understood that the particular embodiments described herein are only intended to explain the present disclosure and are not intended to limit the present disclosure.

### Example Embodiment One

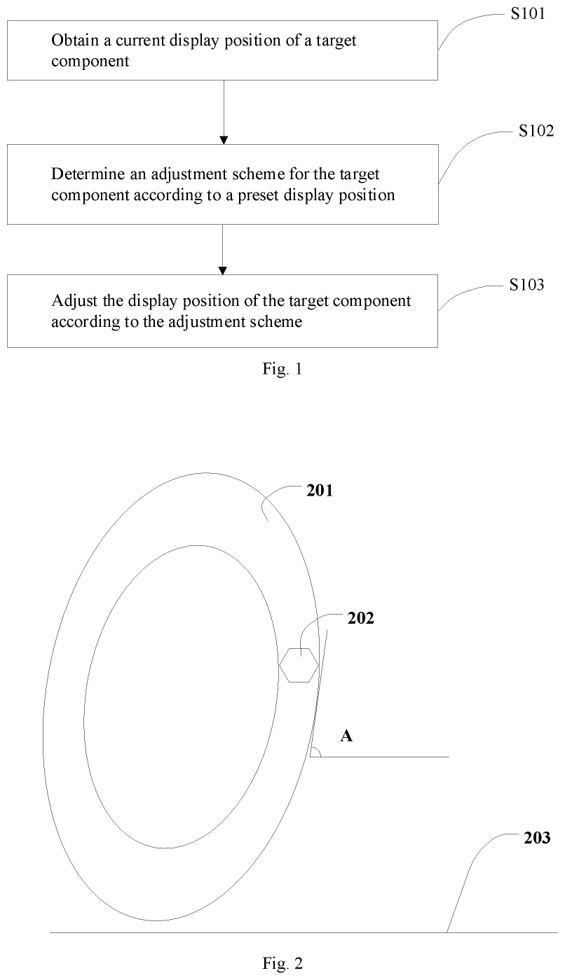

Referring to FIG. 1, a display position adjustment method provided by this embodiment includes:
S101: obtaining a current display position of a target component;
S102: determining an adjustment scheme for the target component according to a preset display position; and
S103: adjusting the display position of the target component according to the adjustment scheme.

A display position adjustment method provided in some embodiments of the present disclosure is applied to a terminal device, and the target component may be one or more windows displayed on a display screen of the terminal device, such as a web page opened by the current browser. The target component may also be the time and date, etc. currently displayed on the display screen. The target component may also be internal interfaces of some applications, such as a playing page of a music playing application and a video playing interface of a video playing application. It should be noted that the selection of the target component may be set by a user or a person skilled in the art according to requirements, and the target component may be a single component or a combination formed by combining multiple components, that is, the number of individual components included in the target component is not limited here.

In some embodiments, the user may also set the arrangement and display positions of multiple components, so as to achieve the purpose of combined display. For example, the time and notifications of a lock screen are combined, or several spaces and icons of a home screen are combined.

In some embodiments, the current display positions of the target components may be adjacent or displayed separately. It is also possible that the target components may include two components, in which at least part of one component and at least part of the other component are displayed in an overlapping manner. For example, a date component is displayed within a weather component. When two components are displayed in an overlapping manner, the display colors and transparencies of the components may be adjusted to achieve the effect that the information of both components can be read by the user.

In some embodiments, before obtaining the current display position of the target component, the current state of the terminal device may also be determined, such as whether the display screen is “ON”, whether there is a large change in device position such as shaking, picking up or putting down, whether there is external pressure such as external pressing, whether there is a specific external activation signal such as voice command, whether there is an incoming call, etc. It should be noted that the relationship between the current state of the terminal device and the target component can be set by the user according to his/her actual needs. As an example, if the display screen of the terminal device is “ON”, the current display position of a time component is obtained. As another example, if the terminal device is shaken, the current display position of a music component is obtained. As still another example, if there is an incoming call, the current display position of a telephone component is obtained.

In some embodiments, the current display position of the target component may be a positional relationship between a display screen including the current display position of the target component and a horizontal plane. For example, as shown in FIG. 2, the target component 202 is currently displayed on the display screen 201, the display screen 201 is a curved screen, and the included angle between the current target component 202 and the horizontal plane 203 is A.

It should be noted that the horizontal plane in the embodiment of the present disclosure can be understood as a plane perpendicular to gravity, or a plane preset by the user. It is also possible to set a plane parallel to the ground as a horizontal plane according to the current geographic location of the terminal device. Further, the horizontal plane can be understood as a reference plane. Of course, the user may also set the plane parallel to gravity as a horizontal plane.

In some embodiments, if the terminal device is currently in a screen-off state, the current display position of the target component may be set to the display position of the target component on the display screen when the terminal device was turned on last time. It should be noted that when the terminal device is in the screen-off state, the target component may be configured such that its relative position with respect to the display screen of the terminal device is unchanged.

It should be noted that the screen-off or screen-on of the terminal device in the embodiment of the present disclosure can be understood as whether the content displayed on the screen of the terminal device can be observed by the user.

In some embodiments, it is also possible to set whether to obtain the current display position of the target component according to whether the terminal device is subjected to a screen locking or unlocking operation.

In some embodiments, the preset display position includes a position of the display position of the target component relative to a horizontal plane.

It should be noted that the display position of the target component can be understood as the position of the display screen, and the preset display position in this case is the position of the display screen currently displaying the target component relative to the horizontal plane. The position may be set according to the user's usage habits.

It should be noted that the current display position of the target component may be obtained by means of data analysis of various sensors. For example, the current display position of the target component is obtained by means of a gyroscope, an attitude sensor, etc.

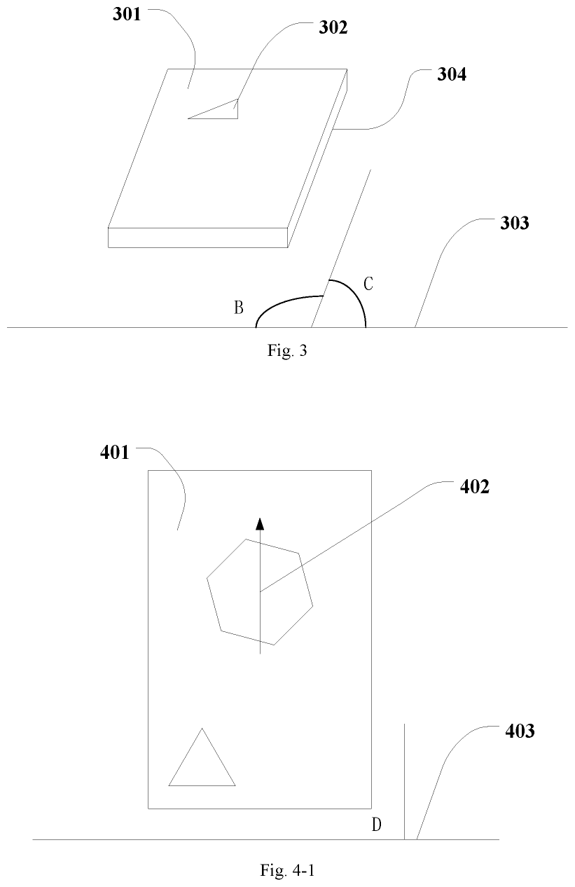

In some embodiments, the preset display position can be understood as the included angle between the plane where the display screen displaying the target component is located and the horizontal plane. As two included angles can be formed between two intersecting planes, it should be further noted that the included angle in the embodiment of the present disclosure is the included angle from the direction of the display screen that the user can see to the direction of the horizontal plane. For example, as shown in FIG. 3, the terminal device includes a main screen and a back screen. A display screen 301 of the main screen currently has an included angle B with the horizontal plane. A display screen 302 of the back screen currently has an included angle C with the horizontal plane.

It should be noted that when the display screen of the terminal device is currently flat, the preset display position may include a distance between the target component and the highest point of the display screen in a certain direction of the terminal device. Of course, the preset display position may also be a fixed position set by the user.

In some embodiments, the preset display position includes not only the included angle between the display position of the target component and the horizontal plane, but also a preset orientation of the target component.

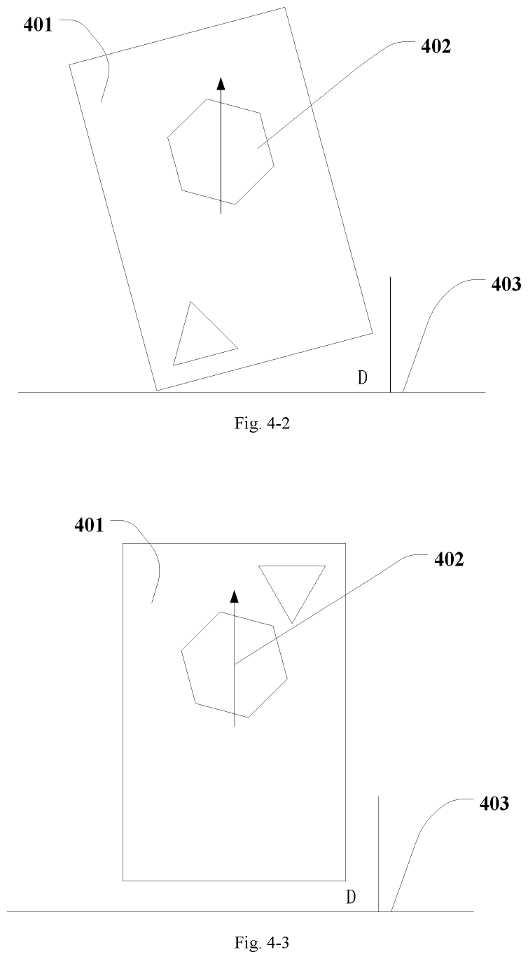

In some embodiments, when the display screen of the terminal device is flat, the preset orientation of the target component is obtained, and the included angle between the preset orientation and the horizontal plane is taken as the current display position. Reference can be made to FIGS. 4-1, 4-2 and 4-3 for details. As shown in FIG. 4-1, the preset display position of the target component 402 is such that the display screen 401 is perpendicular to the horizontal plane 403, and the included angle is D, and the preset orientation of the target component is perpendicular to the horizontal plane. As shown in FIG. 4-2, after the terminal device is rotated by for a certain angle, although the included angle between the display screen 401 of the terminal device displaying the target component 402 and the horizontal plane 403 is still D, the display directions of other components displayed by the display screen all change with the terminal device, but do not change relative to the terminal device. After being adjusted by the method of the embodiment of the present disclosure, the display direction of the target component 402 is still upward. As shown in FIG. 4-2, after the terminal device is rotated by 180 degrees, the display direction of the target component 402 is still upward after being adjusted by the method of the embodiment of the present disclosure.

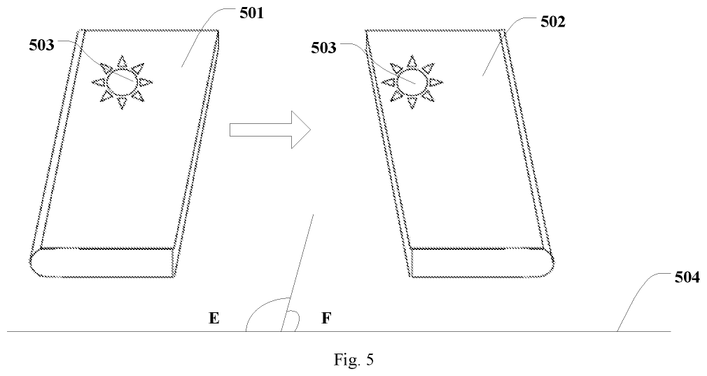

In some embodiments, the terminal device includes two display screens. It should be noted that the two display screens may be two separate display screens, or two display screens with different display directions formed by folding one display screen. As shown in FIG. 5, the terminal device includes a first display screen 501 and a second display screen 502. A target component 503 is initially displayed on the first display screen 501, and has a preset display position that is a position at an included angle E with the horizontal plane 504. After the position or attitude of the terminal device changes, according to the method provided by the embodiment of the present disclosure, in order to make the target component 503 still consistent with the preset display position, the target component 503 is changed to be displayed on the second display screen 502. As to how to determine the display position of the target component 503 after the change in attitude, the following ways may be adopted. When the attitude of the terminal device changes, projection coordinates of a new display area on a physical screen are calculated according to attitude data of the terminal device collected by a sensor. The display unit is then notified to redraw the designated target component and dynamically adjust its display position to the current display position of the second display screen 502. When the mobile phone is turned over or undergoes other attitude changes, target components are all recalculated and redrawn according to the above principle, such that the target components are always dynamically maintained in the position specified in the setting (the position of an upward screen display area).

In some embodiments, after obtaining a current display position of a target component and before determining an adjustment scheme for the target component according to a preset display position, the method further includes:

obtaining available display positions of the terminal device, where the available display positions include a current position of each area of a display screen of the terminal device relative to the horizontal plane.

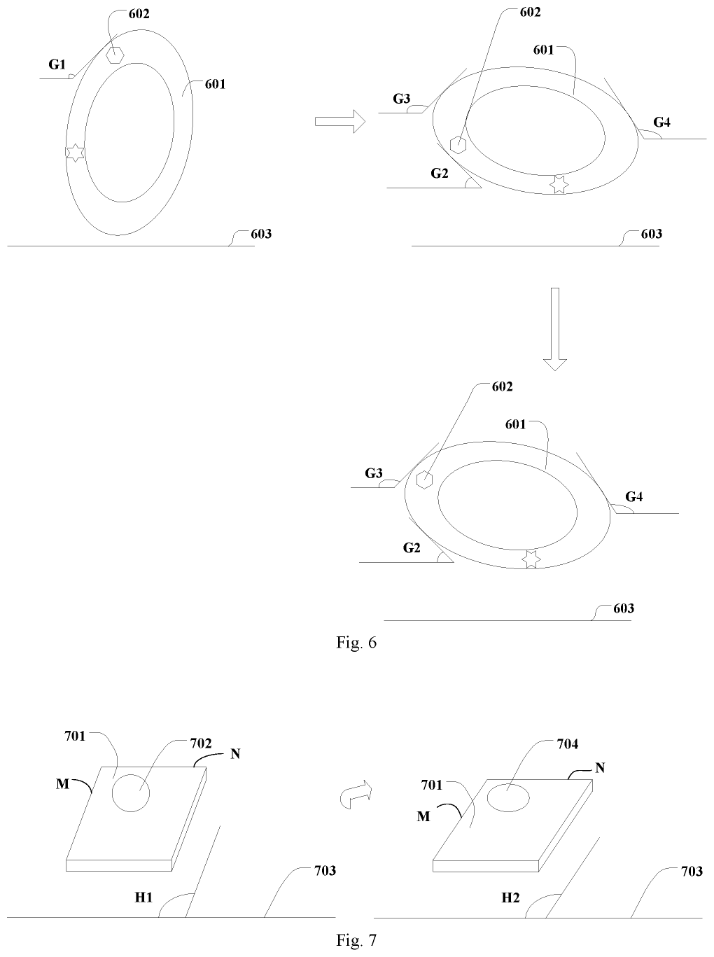

It should be noted that the available display positions can be understood as the included angle between each area of the display screen of the terminal device and the horizontal plane. When the display screen of the terminal device has a curved surface, a number of areas are pre-allocated to the terminal device, and the included angle between the central point of each area or a tangent plane of the designated position and the horizontal plane is taken as an available display position. As shown in FIG. 6, the display screen 601 of the terminal device is ring-shaped, and the preset display position of the target component 602 is an included angle G1 with respect to the horizontal plane 603. When the display screen changes, the current display position of the target component 602 is an included angle G2 with respect to the horizontal plane. At this time, available display positions are obtained. As shown in the figure, the current available display positions are respectively the included angle G2 with respect to the horizontal plane, an included angle G3 with respect to the horizontal plane, and an included angle G4 with respect to the horizontal plane. In some embodiments, assuming that the included angle of G3 is equal to G1, the target component 602 can be projected to the area where the included angle of G3 is located for display.

In some embodiments, an optimal available display position is determined according to a preset rule if none of the available display positions matches the preset display position.

In some embodiments, assuming that G3 and G1 in FIG. 6 are not equal, at this time, G3, G2 and G4 are obtained, and the area where the one selected from the three that has the smallest error from G1 is taken as the optimal available display position. Assuming that G3 is the optimal available display position, the target component 602 is projected to the area where the included angle of G3 is located for display.

It should be noted that the preset rule may be to select the available display position with the smallest error from the preset display position as the optimal available display position. Of course, the preset rule may also be other feasible rules set by the user, such as fixedly selecting a certain position as the optimal available display position.

In some embodiments, adjusting the display position of the target component according to the adjustment scheme includes: determining, according to a positional relationship between the optimal available display position and the preset display position, a display form of the target component at the optimal available display position.

It should be noted that the display form includes the deformation of the target component. In some embodiments, A feasible way to determine the display form of the target component at the optimal available display position may be to project a target space on the optimal available display position according to the projection relationship between the optimal available display position and the preset display position. Referring to FIG. 7, a preset display position of a target component 702 is an included angle H1 between a display screen 701 including the area where the target component 702 is located and a horizontal plane 703. When the attitude of the terminal device changes, the only available display position of the terminal device is an included angle H2 between the display screen and the horizontal plane. At this time, there is an included angle H2-H1 between the optimal available display position and the preset display position. A feasible display way is to project the target component 702, determine the display form of the target component 702 as a target component 704, and display the target component on the display screen 701.

In some embodiments, the preset display position further includes a distance between the target component and a predefined display screen edge of the terminal device.

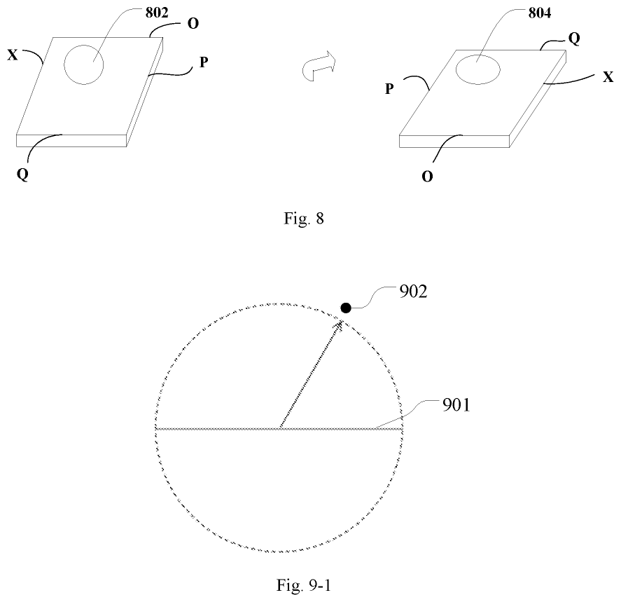

It should be noted that the predefined display screen edge of the terminal device may be a specified edge of the display screen of the terminal device. The predefined display screen edge of the terminal device may also be a display screen edge in a certain direction after the change in attitude. For example, as shown in FIG. 7, when the target component 702 is in the preset display position, its central point has a distance M1 from a display screen edge M and a distance N1 from a display screen edge N. After the attitude of the terminal device is changed, the distance from the new target component 704 to the display screen edge M is still M1, and to the display screen edge N is still N1. As another example, referring to FIG. 8, the predefined display screen edges of the terminal device are left and upper display screen edges when the terminal device faces the user. When a target component 802 is in the preset display position, its central point has a distance X1 from a display screen edge X and a distance O1 from a display screen edge O. After the attitude of the terminal device is changed, the new target component 804 has a distance P1 from a display screen edge P and a distance Q1 from a display screen edge Q, where P1 is equal to X1 and Q1 is equal to O1.

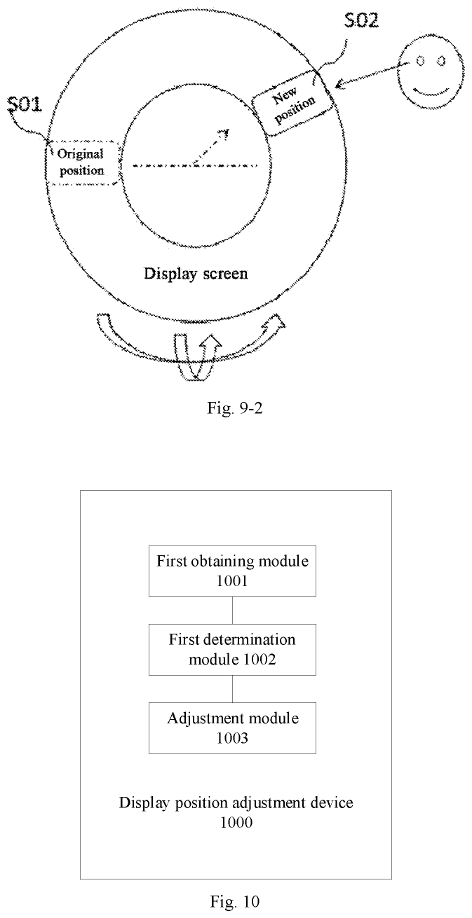

The display position adjustment method provided by the embodiment of the present disclosure will be further explained below by taking a smart bracelet with a flexible display as the terminal device as an example, a display screen of the bracelet being a curved display screen. Reference is made to FIGS. 9-1 and 9-2, As shown in FIG. 9-1, first, the user can select a target component to be set on a setting interface of the terminal device, and then select the relative position of a target component relative to the horizontal plane. Specifically, the selection may be performed by dragging to set the preset display position. Referring to FIG. 9-2, S01 refers to the current display position of the target component, and S02 refers to the new display position of the target component in the setting. After the fixed position is set, the target component will automatically remain at the set position S02 at an angle relative to the horizontal plane, no matter how the position of the display screen is changed, such as rotating or turning over.

The embodiment of the present disclosure provides a display position adjustment method, which includes obtaining a current display position of a target component, determining an adjustment scheme for the target component according to a preset display position, and adjusting the display position of the target component according to the adjustment scheme. It solves the problem whereby components are all displayed in relatively fixed positions relative to the terminal device and cannot be displayed according to the actual application scenarios and usage habits of the user, and the user experience is low. The current display position of the target component can be adjusted according to the preset display position. When the preset display position is set according to the application scenarios and usage habits of the user, it is no longer necessary for the user to manually adjust the display position of the target component, so that it is possible to automatically formulate an adjustment scheme and adjust the target component to a suitable position according to the adjustment scheme, thereby improving the user experience.

Further, by obtaining the available display positions of the terminal device, if there is no available display position matching the preset display position when none of the available display positions matches the preset display position, an optimal available display position may be determined by means of a preset rule, which can avoid that there is no area in the current display screen of the terminal device that can meet preset display area conditions due to the change in the attitude of the terminal device. In such a scene, however, it is sometimes necessary to display the target component, so the target component may be displayed by selecting the optimal available display position as an alternative.

Further, when the target component is displayed at the optimal available display position, if the preset display position is set according to the user's habitual viewing angle, at this time, due to the optimal available display position differing from the user's habitual viewing angle to a certain extent, the display form of the target component is redetermined and the size, shape, etc. of the target component are changed as required, such that the user can watch the target component better and the user experience is further improved.

Further, by specifying the distance between the target component and a predefined display screen edge of the terminal device, it can be achieved in some specific scenes that the relative display position of the target component is in the preset display position no matter how the attitude of the terminal device changes.

### Example Embodiment Two

This embodiment further provides a display position adjustment device. As shown in FIG. 10, the display position adjustment device 1000 includes:
a first obtaining module 1001 configured to obtain a current display position of a target component;
a first determination module 1002 configured to determine an adjustment scheme for the target component according to a preset display position, where the preset display position includes a position of the display position of the target component relative to a horizontal plane; and
an adjustment module 1003 configured to adjust the target component according to the adjustment scheme to display the target component at the preset display position.

A display position adjustment method provided in some embodiments of the present disclosure is applied to a terminal device, and the target component may be one or more windows displayed on a display screen of the terminal device, such as a web page opened by the current browser. The target component may also be the time and date, etc. currently displayed on the display screen. The target component may also be internal interfaces of some applications, such as a playing page of a music playing application and a video playing interface of a video playing application. It should be noted that the selection of the target component may be set by a user or a person skilled in the art according to requirements, and the target component may be a single component or a combination formed by combining multiple components, that is, the number of individual components included in the target component is not limited here.

In some embodiments, the user may also set the arrangement and display positions of multiple components, so as to achieve the purpose of combined display. For example, the time and notifications of a lock screen are combined, or several spaces and icons on a home screen are combined.

In some embodiments, the current display positions of the target components may be adjacent or displayed separately. It is also possible that the target components may include two components, in which at least part of one component and at least part of the other component are displayed in an overlapping manner. For example, a date component is displayed within a weather component. When two components are displayed in an overlapping manner, the display colors and transparencies of the components may be adjusted to achieve the effect that the information of both components can be read by the user.

In some embodiments, before obtaining the current display position of the target component, the current state of the terminal device may also be determined, such as whether the display screen is “ON”, whether there is a large change in device position such as shaking, picking up or putting down, whether there is external pressure such as external pressing, whether there is a specific external activation signal such as voice command, whether there is an incoming call, etc. It should be noted that the relationship between the current state of the terminal device and the target component can be set by the user according to his/her actual needs. As an example, if the display screen of the terminal device is “ON”, the current display position of a time component is obtained. As another example, if the terminal device is shaken, the current display position of a music component is obtained. As still another example, if there is an incoming call, the current display position of a telephone component is obtained.

In some embodiments, the current display position of the target component may be a positional relationship between a display screen including the current display position of the target component and a horizontal plane. For example, as shown in FIG. 2, the target component 202 is currently displayed on the display screen 201, the display screen 201 is a curved screen, and the included angle between the current target component 202 and the horizontal plane 203 is A.

It should be noted that the horizontal plane in the embodiment of the present disclosure can be understood as a plane perpendicular to gravity, or a plane preset by the user. It is also possible to set a plane parallel to the ground as a horizontal plane according to the current geographic location of the terminal device. Further, the horizontal plane can be understood as a reference plane. Of course, the user may also set the plane parallel to gravity as a horizontal plane.

In some embodiments, if the terminal device is currently in a screen-off state, the current display position of the target component may be set to the display position of the target component on the display screen when the terminal device was turned on last time. It should be noted that when the terminal device is in the screen-off state, the target component may be configured such that its relative position with respect to the display screen of the terminal device is unchanged.

It should be noted that the screen-off or screen-on of the terminal device in the embodiment of the present disclosure can be understood as whether the content displayed on the screen of the terminal device can be observed by the user.

In some embodiments, it is also possible to set whether to obtain the current display position of the target component according to whether the terminal device is subjected to a screen locking or unlocking operation.

In some embodiments, the preset display position includes a position of the display position of the target component relative to a horizontal plane.

It should be noted that the display position of the target component can be understood as the position of the display screen, and the preset display position in this case is the position of the display screen currently displaying the target component relative to the horizontal plane. The position may be set according to the user's usage habits.

In some embodiments, the preset display position can be understood as the included angle between the plane where the display screen displaying the target component is located and the horizontal plane. As two included angles can be formed between two intersecting planes, it should be further noted that the included angle in the embodiment of the present disclosure is the included angle from the direction of the display screen that the user can see to the direction of the horizontal plane. For example, as shown in FIG. 3, the terminal device includes a main screen and a back screen. A display screen 301 of the main screen currently has an included angle B with the horizontal plane. A display screen 302 of the back screen currently has an included angle C with the horizontal plane.

It should be noted that the current display position of the target component may be obtained by means of data analysis of various sensors. For example, the current display position of the target component is obtained by means of a gyroscope, an attitude sensor, etc.

It should be noted that when the display screen of the terminal device is currently flat, the preset display position may include a distance between the target component and the highest point of the display screen in a certain direction of the terminal device. Of course, the preset display position may also be a fixed position set by the user.

In some embodiments, the preset display position includes not only the included angle between the display position of the target component and the horizontal plane, but also a preset orientation of the target component.

In some embodiments, when the display screen of the terminal device is flat, the preset orientation of the target component is obtained, and the included angle between the preset orientation and the horizontal plane is taken as the current display position. Reference can be made to FIGS. 4-1, 4-2 and 4-3 for details. As shown in FIG. 4-1, the preset display position of the target component 402 is such that the display screen 401 is perpendicular to the horizontal plane 403, and the included angle is D, and the preset orientation of the target component is perpendicular to the horizontal plane. As shown in FIG. 4-2, after the terminal device is rotated by for a certain angle, although the included angle between the display screen 401 of the terminal device displaying the target component 402 and the horizontal plane 403 is still D, the display directions of other components displayed by the display screen all change with the terminal device, but do not change relative to the terminal device. After being adjusted by the method of the embodiment of the present disclosure, the display direction of the target component 402 is still upward. As shown in FIG. 4-2, after the terminal device is rotated by 180 degrees, the display direction of the target component 402 is still upward after being adjusted by the method of the embodiment of the present disclosure.

In some embodiments, the terminal device includes two display screens. It should be noted that the two display screens may be two separate display screens, or two display screens with different display directions formed by folding one display screen. As shown in FIG. 5, the terminal device includes a first display screen 501 and a second display screen 502. A target component 503 is initially displayed on the first display screen 501, and has a preset display position that is a position at an included angle E with the horizontal plane 504. After the position or attitude of the terminal device changes, according to the method provided by the embodiment of the present disclosure, in order to make the target component 503 still consistent with the preset display position, the target component 503 is changed to be displayed on the second display screen 502. As to how to determine the display position of the target component 503 after the change in attitude, the following ways may be adopted. When the attitude of the terminal device changes, projection coordinates of a new display area on a physical screen are calculated according to attitude data of the terminal device collected by a sensor. The display unit is then notified to redraw the designated target component and dynamically adjust its display position to the current display position of the second display screen 502. When the mobile phone is turned over or undergoes other attitude changes, target components are all recalculated and redrawn according to the above principle, such that the target components are always dynamically maintained in the position specified in the setting (the position of an upward screen display area).

In some embodiments, The display position adjustment device further includes: a second obtaining module configured to obtain available display positions of the terminal device after the first obtaining module obtains the current position of the target component and before the first determination module determines the adjustment scheme for the target component according to the preset display position, where the available display positions include a current position of each area of a display screen of the terminal device relative to the horizontal plane.

It should be noted that the available display positions can be understood as the included angle between each area of the display screen of the terminal device and the horizontal plane. When the display screen of the terminal device has a curved surface, a number of areas are pre-allocated to the terminal device, and the included angle between the central point of each area or a tangent plane of the designated position and the horizontal plane is taken as an available display position. As shown in FIG. 6, the display screen 601 of the terminal device is ring-shaped, and the preset display position of the target component 602 is an included angle G1 with respect to the horizontal plane 603. When the display screen changes, the current display position of the target component 602 is an included angle G2 with respect to the horizontal plane. At this time, available display positions are obtained. As shown in the figure, the current available display positions are respectively the included angle G2 with respect to the horizontal plane, an included angle G3 with respect to the horizontal plane, and an included angle G4 with respect to the horizontal plane. In some embodiments, assuming that the included angle of G3 is equal to G1, the target component 602 can be projected to the area where the included angle of G3 is located for display.

In some embodiments, The display position adjustment device further includes: a second determination module configured to determine an optimal available display position according to a preset rule if none of the available display positions matches the preset display position.

In some embodiments, assuming that G3 and G1 in FIG. 6 are not equal, at this time, G3, G2 and G4 are obtained, and the area where the one selected from the three that has the smallest error from G1 is taken as the optimal available display position. Assuming that G3 is the optimal available display position, the target component 602 is projected to the area where the included angle of G3 is located for display.

It should be noted that the preset rule may be to select the available display position with the smallest error from the preset display position as the optimal available display position. Of course, the preset rule may also be other feasible rules set by the user, such as fixedly selecting a certain position as the optimal available display position.

In some embodiments, the adjustment module includes: an adjustment sub-module configured to determine, according to a positional relationship between the optimal available display position and the preset display position, a display form of the target component at the optimal available display position.

It should be noted that the display form includes the deformation of the target component. In some embodiments, A feasible way to determine the display form of the target component at the optimal available display position may be to project a target space on the optimal available display position according to the projection relationship between the optimal available display position and the preset display position. Referring to FIG. 7, a preset display position of a target component 702 is an included angle H1 between a display screen 701 including the area where the target component 702 is located and a horizontal plane 703. When the attitude of the terminal device changes, the only available display position of the terminal device is an included angle H2 between the display screen and the horizontal plane. At this time, there is an included angle H2-H1 between the optimal available display position and the preset display position. A feasible display way is to project the target component 702, determine the display form of the target component 702 as a target component 704, and display the target component on the display screen 701.

In some embodiments, the preset display position further includes a distance between the target component and a predefined display screen edge of the terminal device.

It should be noted that the predefined display screen edge of the terminal device may be a specified edge of the display screen of the terminal device. The predefined display screen edge of the terminal device may also be a display screen edge in a certain direction after the change in attitude. For example, as shown in FIG. 7, when the target component 702 is in the preset display position, its central point has a distance M1 from a display screen edge M and a distance N1 from a display screen edge N. After the attitude of the terminal device is changed, the distance from the new target component 704 to the display screen edge M is still M1, and to the display screen edge N is still N1. As another example, referring to FIG. 8, the predefined display screen edges of the terminal device are left and upper display screen edges when the terminal device faces the user. When a target component 802 is in the preset display position, its central point has a distance X1 from a display screen edge X and a distance O1 from a display screen edge O. After the attitude of the terminal device is changed, the new target component 804 has a distance P1 from a display screen edge P and a distance Q1 from a display screen edge Q, where P1 is equal to X1 and Q1 is equal to O1.

The embodiment of the present disclosure provides a display position adjustment device, which obtains a current display position of a target component, determines an adjustment scheme for the target component according to a preset display position, and adjusts the display position of the target component according to the adjustment scheme. It solves the problem whereby components are all displayed in relatively fixed positions relative to the terminal device and cannot be displayed according to the actual application scenarios and usage habits of the user, and the user experience is low. The current display position of the target component can be adjusted according to the preset display position. When the preset display position is set according to the application scenarios and usage habits of the user, it is no longer necessary for the user to manually adjust the display position of the target component, so that it is possible to automatically formulate an adjustment scheme and adjust the target component to a suitable position according to the adjustment scheme, thereby improving the user experience.

### Example Embodiment Three

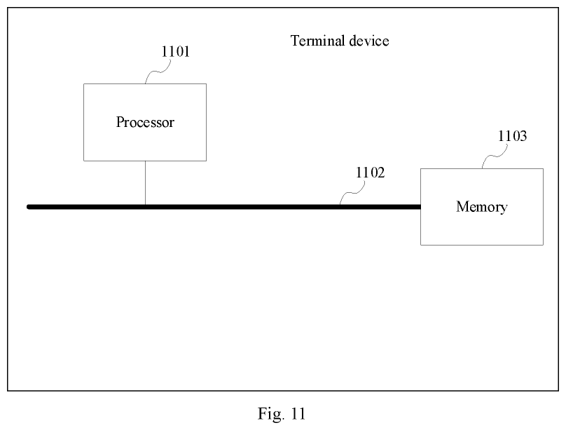

This embodiment further provides a terminal device, as shown in FIG. 11, including a processor 1101, a memory 1103 and a communication bus 1102.

The communication bus 1102 is configured to implement connection and communication between the processor 1101 and the memory 1103.

The processor 1101 is configured to execute one or more computer programs stored in the memory 1103 to implement at least one step of the display position adjustment method in the embodiment one.

This embodiment further provides a computer-readable storage medium including a volatile or nonvolatile, removable or non-removable medium implemented in any method or technology for storing information such as computer-readable instructions, data structures, computer program modules or other data. The computer-readable storage media include, but are not limited to, random access memory (RAM), read-only memory (ROM), electrically erasable programmable read-only memory, EEPROM), flash memory or other memory technologies, compact disc read-only memory (CD-ROM), digital versatile disc (DVD) or other optical disc storage, cassettes, magnetic tapes, magnetic disc storage or other magnetic storage devices, or any other media that can be configured to store desired information and can be accessed by computers.

The computer-readable storage medium in this embodiment may be configured to store one or more computer programs which are executable by a processor to implement at least one step of the display position adjustment method in the example embodiment one.

This embodiment further provides a computer program (or computer software), which may be distributed on a computer-readable medium and executed by a computable device to implement at least one step of the display position adjustment method in the example embodiment one. Moreover, in some cases, at least one step shown or described may be performed in an order different from that described in the above embodiments.

This embodiment further provides a computer program (or computer software), which may be distributed on a computer-readable medium and executed by a computable device to implement at least one step for the display position adjustment device in the example embodiment two. Moreover, in some cases, at least one step shown or described may be performed in an order different from that described in the above embodiments.

It should be understood that in some cases, at least one step shown or described may be performed in an order different from that described in the above embodiments.

This embodiment further provides a computer program product including a computer-readable device on which a computer program as described above is stored. In this embodiment, the computer-readable device may include the computer-readable storage medium as described above.

The embodiment of the present disclosure provides a display position adjustment method and device, a terminal device and a non-transitory computer-readable storage medium. The method includes obtaining a current display position of a target component, determining an adjustment scheme for the target component according to a preset display position, and adjusting the display position of the target component according to the adjustment scheme. One of the technical problems in the existing technology that has been solved at least to a certain extent includes the problem whereby components are all displayed in relatively fixed positions relative to the terminal device and cannot be displayed according to the actual application scenarios and usage habits of the user, and the user experience is low. The current display position of the target component can be adjusted according to the preset display position. When the preset display position is set according to the application scenarios and usage habits of the user, it is no longer necessary for the user to manually adjust the display position of the target component, so that it is possible to automatically formulate an adjustment scheme and adjust the target component to a suitable position according to the adjustment scheme, thereby improving the user experience.

An embodiment of the present disclosure provides a display position adjustment device, a terminal device and a non-transitory computer-readable storage medium. One of the technical problems in the existing technology that has been solved at least to a certain extent includes the problem whereby components are all displayed in relatively fixed positions relative to the terminal device and cannot be displayed according to the actual application scenarios and usage habits of the user, and the user experience is low. The current display position of the target component can be adjusted according to the preset display position. When the preset display position is set according to the application scenarios and usage habits of the user, it is no longer necessary for the user to manually adjust the display position of the target component, so that it is possible to automatically formulate an adjustment scheme and adjust the target component to a suitable position, thereby improving the user experience.

Therefore, it should be understood by those having ordinary skills in the art that all or some of the steps of the methods, systems and functional modules/units in the devices disclosed above can be implemented as software (which may be implemented by computer program codes executable by a computing device), firmware, hardware and appropriate combinations thereof. In the hardware implementation, the division between functional modules/units mentioned in the above description does not necessarily correspond to the division of physical components; for example, a physical component may have multiple functions, or a function or step may be performed cooperatively by several physical components. Some or all of the physical components may be implemented as software executed by a processor, such as a central processing unit, a digital signal processor or a microprocessor, or as hardware, or as an integrated circuit, such as an application specific integrated circuit.

Furthermore, it is well known to those having ordinary skills in the art that communication media typically contain computer-readable instructions, data structures, computer program modules or other data in a modulated data signal such as a carrier wave or other transmission mechanism, and can include any information delivery media. Therefore, the present disclosure is not limited to any particular combination of hardware and software.

The foregoing is a detailed description of embodiments the present disclosure in conjunction with particular implementations, and implementations of the present disclosure should not be construed as being limited to the description. For those having ordinary skills in the art, several simple deductions or substitutions can be made without departing from the concept of the present disclosure, which should be regarded as falling within the scope of protection of the present disclosure.

1. A display position adjustment method, which is applied to a terminal device, the method comprising:
obtaining a current display position of a target component;
determining an adjustment scheme for the target component according to a preset display position, wherein the preset display position comprises a position of the display position of the target component relative to a horizontal plane; and
adjusting the display position of the target component according to the adjustment scheme.

2. The display position adjustment method according to claim 1, further comprising, after obtaining a current display position of a target component and before determining an adjustment scheme for the target component according to a preset display position:
obtaining available display positions of the terminal device, wherein the available display positions include a current position of each area of a display screen of the terminal device relative to the horizontal plane.

3. The display position adjustment method according to claim 2, further comprising:
determining an optimal available display position according to a preset rule in response to none of the available display positions matching the preset display position.

4. The display position adjustment method according to claim 3, wherein adjusting the display position of the target component according to the adjustment scheme comprises:
determining, according to a positional relationship between the optimal available display position and the preset display position, a display form of the target component at the optimal available display position.

5. The display position adjustment method according to claim 1, wherein the preset display position further comprises:
a distance between the target component and a predefined display screen edge of the terminal device.

6-10. (canceled)

11. A terminal device, comprising:
a processor;
a memory storing one or more computer programs; and
a communication bus configured to implement connection and communication between the processor and the memory;
wherein the processor is configured to execute the one or more computer programs to implement a display position adjustment method which is applied to a terminal device, the method comprises:
obtaining a current display position of a target component;
determining an adjustment scheme for the target component according to a preset display position, wherein the preset display position comprises a position of the display position of the target component relative to a horizontal plane; and
adjusting the display position of the target component according to the adjustment scheme.

12. A non-transitory computer-readable storage medium storing one or more computer programs,
wherein the one or more computer programs are executable by one or more processors to implement a display position adjustment method which is applied to a terminal device, the method comprises:
obtaining a current display position of a target component;
determining an adjustment scheme for the target component according to a preset display position, wherein the preset display position comprises a position of the display position of the target component relative to a horizontal plane; and
adjusting the display position of the target component according to the adjustment scheme.

13. The display position adjustment method according to claim 2, wherein the preset display position further comprises:
a distance between the target component and a predefined display screen edge of the terminal device.

14. The display position adjustment method according to claim 3, wherein the preset display position further comprises:
a distance between the target component and a predefined display screen edge of the terminal device.

15. The display position adjustment method according to claim 4, wherein the preset display position further comprises:
a distance between the target component and a predefined display screen edge of the terminal device.
